(19) United States
(12) Patent Application Publication
(10) Pub. No.: US 2024/0130839 A1
(43) Pub. Date: Apr. 25, 2024

(54) DENTAL PROSTHETIC DEVICE

(71) Applicant: BIOTECH DENTAL, Salon De Provence (FR)

(72) Inventor: Pascal BREYSSE, Saint-Germain-Nuelles (FR)

(21) Appl. No.: 18/548,157

(22) PCT Filed: Mar. 1, 2022
(86) PCT No.: PCT/IB2022/051777

§ 371 Date: Aug. 27, 2023

(30) Foreign Application Priority Data
Mar. 2, 2021 (FR) FR2102018

(51) Int. Cl. A61C 8/00

(52) U.S. Cl. CPC A61C 8/0069; A61C 8/0068; A61C 8/008

(57) ABSTRACT

Disclosed is a dental prosthetic device having an implant, a cap and an abutment interposed between the implant and the cap. The abutment includes an abutment head which is at least partially delimited by an abutment external face and which is configured to retain the cap. The abutment has an abutment body with an attachment to the implant. Retention is accomplished by a nesting arraignment for fitting the abutment head inside a cavity which is formed inside the cap and which is at least partially delimited by a cap internal face. The cap is screwed onto the abutment head. The cap internal face is provided with a tab which is in contact against the abutment external face. A space is left between a point of contact of the cap internal face and a cone lip of the cap internal face between the abutment external face and the cap internal face.

### FIELD OF THE INVENTION

The present invention relates to a dental prosthetic device comprising an implant intended to be built up in a bone of a gum of a patient, an abutment built up on the implant and a cap which is provided with a prosthesis which is intended to be attached on the abutment. The goal of the invention is such a dental prosthetic device.

### DESCRIPTION OF RELATED ART

The documents FR 3,053,884, US 2012/0,295,223, U.S. Pat. No. 5,006,069 and CN 112,315,603 respectively describe a dental prosthetic device comprising an implant, a cap and an abutment interposed between the implant and the cap. The abutment comprises an abutment head which is equipped with retaining means for the cap. The abutment also comprises an abutment body which is provided with means of attachment to the implant. The retaining means comprise means of nesting the abutment head inside a cavity arranged inside the cap.

The retaining means of the dental prosthetic devices described by the documents FR 3,053,884 and US 2012/0,295,223 do not have any means of screwing the cap onto the abutment head. The result of this is that the retaining means are exclusively nesting means which prove to be insufficient for guaranteeing a solid and lasting attachment of the cap onto the abutment head. Further, many practitioners wish to have means of retention by screwing of the cap onto the abutment head because of habits formed in the field and the comfort of placing the cap onto the abutment head. This retaining means is instead intended for temporary or removable prosthetic restorations. The means of retention by screwing is for its part intended for permanent attached prosthetic restorations.

The means for retaining dental prosthetic devices described by the documents U.S. Pat. No. 5,006,069 and CN 112315603 combine means of nesting the abutment head inside the cavity arranged inside the cap and means of screwing the cap onto the abutment head.

The cap described in the document U.S. Pat. No. 5,006,069 comprises an inner cap surface which is completely frustoconical and which is flattened against an outer surface of the abutment which comprises the abutment head. In other words, the inner cap surface and the abutment outer surface are abutting over a full height of the abutment head. In yet other words, the inner cap surface and the outer abutment surface are nesting in tight contact over the full height of the abutment head. Such nesting has the disadvantage of generating significant frictional forces during the placement of the cap onto the abutment head by the practitioner, so far as making such an nesting impossible in some cases, in particular if the dimensional tolerances inherent in such a force nesting are not met or poorly met. Further, even if an angle of the frustoconical part is sufficiently open for reducing or canceling the frictional forces, it is seen that the device does not comprise an indexing system for the abutment relative to the implant and the abutment relative to the cap. Also, the abutment is screwed onto the implant and not through screwed with an abutment screw. Such a dental prosthetic device therefore needs to be improved.

The cap described by document CN 112315603 comprises an inner cap surface comprising an upper zone of the inner cap surface which is frustoconical and an inner zone of the inner cap surface which is frustoconical and a lower zone of the inner cap surface which is cylindrical. The upper zone of the inner cap surface is flattened against an upper portion of the outer abutment surface which comprises the outer abutment surface, whereas the lower zone of the inner cap surface is totally arranged away from a lower portion of the outer abutment surface that the outer abutment surface also comprises. The result of this is a minimalist nesting of the cap on the abutment head, where the upper portion of the outer abutment surface is notoriously at a lower height than a height of the lower portion of the outer cap surface, such that the nesting of the cap on the abutment head is extremely reduced and nearly reduced to nothing. Such a dental prosthetic device therefore needs to be improved.

### BRIEF SUMMARY OF THE INVENTION

A goal of the present invention is to propose a dental prosthetic device comprising an implant intended to be built up in a bone of a gum of a patient, an abutment intended to be built up on the implant and a cap which could be provided with a dental prosthesis which is intended to be attached on the abutment, where the cap is indifferently a healing cap or else a permanent cap equipped with a dental prosthesis. It is understood that the healing cap is intended to be installed on the abutment and the implant temporarily, for example for a few weeks, in particular during a phase of healing of the gums around the healing cap. During this time, the healing cap must be securely attached onto the abutment and implant, without risk of escaping therefrom. After this healing time, it must be possible to easily and quickly remove this healing cap without altering the dental abutment and/or implant, such that the healing cap can be replaced by a cap intended for prosthesis. It is understood that the permanent cap and prosthesis are intended to be installed for a long time, in particular several years, even decades, on the dental abutment and implant.

It is thus understood that a good compromise is sought between a firm and reliable hold on the abutment and implant by the prosthesis equipped cap and an easy removal of the healing cap, in particular in order for replacement thereof by a permanent prosthesis.

Another goal of the present invention is to propose a dental prosthetic device offering various usage possibilities to practitioners who have different habits from each other for installing the dental prosthetic device on the patient.

A device from the present invention is a dental prosthetic device extending principally along an axis of extension and comprising at least one implant, one cap and an abutment which is interposed between the implant and the cap. The abutment comprises an abutment body provided with means of attachment to the implant. The abutment comprises an abutment head which is at least partially delimited by an outer abutment surface. The abutment head is equipped with retaining means for the cap. The retaining means comprise means of nesting the abutment head inside a cavity. The cavity is arranged inside the cap and is at least partially delimited by an inner cap surface. The retaining means comprise means for screwing the cap onto the abutment head.

According to the present invention, the inner cap surface is provided with a tab which is in contact against the outer abutment surface, where a spacing is arranged axially between a contact point of the inner cap surface and a cone lip of the inner cap surface. Since the spacing is arranged radially between the outer abutment surface and the inner cap surface.

These arrangements are such that the tab is bearing against the outer abutment surface for keeping the cap on the abutment head, while the spacing avoids contact between the inner cap surface and the abutment head over the entire height of the abutment head. It is understood that a first better possible compromise is achieved between an ease of placement of the cap on the abutment head and an optimized hold of the cap on the abutment head, where this hold is supported by the means of screwing the cap onto the abutment head. It is understood that a second better possible compromise is achieved between robust screwing means which compensate for reduced retention by nesting because of the spacing, while the presence of the spacing making it easier to place the cap onto the abutment head.

The dental prosthetic device advantageously comprises any one at least of the following characteristics, taken alone or in combination:
The tab extends radially around the axis of extension of the dental prosthetic device and extends axially from a lower cap end to the contact point. It is understood that the tab thus forms a guiding ramp for the cap during the placement of the cap by nesting onto the abutment head.
The tab forms a sealing member between the cap and the abutment head, where the sealing member is laid out for avoiding the entry of dirt between the cap and the abutment head. It is understood that the tab begins at the lower cap end in order to avoid jamming food in particular between the cap and the abutment head.
The contact point is arranged at a first distance from the lower cap end which is less than a second distance taken between the lower cap end and the cone lip.
The first distance is less than half of the second distance.
The first distance is less than a quarter of the second distance.
The lower cap end adjoins a flange which delimits the abutment body and the abutment head.
The nesting means comprise a frustoconical layout of the abutment head and a complementary frustoconical layout of the cavity laid out inside the cap.
The abutment head is laid out at least partially in a first conical portion with a shape complementary to a second conical portion according to which the inner cap surface is at least partially laid out.
The second conical portion extends axially at least between the lower cap end and the cone lip.
The second conical portion extends axially between the lower cap end and the contact point.
The first conical portion extends axially at least between the flange and a cone edge which the outer abutment surface comprises.
The first cone portion extends axially between the flange and the contact point.
The cone edge is arranged facing the cone lip.
The cone edge is in contact with the cone lip.
The abutment head comprises an axial crown which extends axially between the cone edge and an upper abutment end. It is understood that the axial crown is the upper part of the abutment head which extends above in particular the conical layout of the abutment head.
The abutment is formed of a single unit assembly comprising the abutment head and the abutment body.
The screwing means include a cap-attachment screw at least partially housed inside an axial abutment channel which the abutment comprises.
A first minimum diameter of the axial abutment channel is greater than a second maximum diameter of the abutment attachment screw.
The cap-attachment screw comprises a lower cap screw end which is provided with a cap screw threading engaging with an abutment threading which is complementary to the cap screw threading and which is arranged on an inner abutment surface delimiting the axial abutment channel.
The cap-attachment screw comprises an upper cap screw end comprising a cap screw head which is in contact against a cap shoulder arranged on the inner cap surface.
The cap-attachment screw extends at least partially inside an axial cap channel comprising an upper zone which houses the cap screw head and which is delimited at least partially by the cap shoulder.
The axial cap channel comprises an intermediate zone which houses the axial crown and at least one radial finger which the abutment head comprises.
The intermediate zone is interposed between the upper zone and the cavity.
The cap extends axially between an upper cap end and the lower cap end, where the upper cap end is provided with an upper cap opening which is shaped to allow insertion of the cap-attachment screw inside the axial cap channel which extends axially between the cap upper end and the cap lower end and which comprises the cavity.
The axial cap channel comprises an upper zone which is intended to house the cap screw head and which is delimited at least partially by the cap shoulder.
The upper zone extends above an intermediate zone of the axial cap channel, where the intermediate zone houses the axial crown of the abutment head and the radial finger.
The intermediate zone is interposed between the upper zone and the cavity.
The cap is provided with a prosthesis.
The prosthesis is equipped with an axial prosthetic channel which extends axially between an upper prosthetic surface and an orifice which is shaped for receiving the cap.
The axial prosthetic channel extends between an upper prosthetic opening and the orifice, where the axial prosthetic channel comprises a chamber extending above the cap, and where the chamber is laid out for housing the cap screw head during an operation of unscrewing the cap-attachment screw.
A channel diameter taken orthogonally to the axis of extension between two diametrically opposite points of the axial prosthetic channel is less than a chamber diameter taken orthogonally to the axis of extension between two diametrically opposite points of the chamber.
The cap comprises an outer cap surface which is provided with an indexing flat intended to index the prosthesis on the cap.
The inner cap surface is provided with at least one member suited for engaging with the radial finger of the abutment head for indexing the cap on the abutment.

According to another approach of the invention, the dental prosthetic device advantageously comprises any one at least of the following characteristics, taken alone or in combination:
The implant is intended to be attached, in particular by screwing or the like, to the inside of the bone of a gum of a patient. For this purpose, the implant comprises an outer implant surface which is provided with at least one helical ramp for screwing.
The implant comprises an axial implant channel which opens out through an upper implant surface and which does not open out through a lower implant surface. In that way, the axial implant channel comprises an axial implant opening through which the abutment body extends in order to be housed inside the axial implant channel.
The cap is, without distinction, a healing cap or else a cap equipped with a prosthesis. The healing cap is intended to be temporarily and removably attached onto the abutment. It is understood that the healing cap is intended to be attached onto the implant via the abutment for a short time. For example, a short time is of order a few weeks. The healing cap is in particular intended to be replaced by a permanent cap equipped with a permanent prosthesis intended to be installed for at least several years, even decades.
The abutment comprises the abutment body which is intended to be housed inside the axial implant channel and the abutment head which is intended to emerge above the axial implant opening.
The abutment body and the abutment head extend along respective axes which are coincident or distinct.
The abutment is equipped with means for indexing the abutment inside the axial implant channel.
The abutment comprises an upper abutment end which is laid out in an axial crown provided with at least one radial finger intended for indexing a positioning of the cap on the abutment.
The abutment houses an axial abutment channel which opens out through the upper abutment end and a lower abutment end.
The abutment body is built up on the implant via attachment means which comprise an abutment attachment screw intended to be lodged inside the axial abutment channel in order to through screw the abutment onto the implant.
The nesting means comprise a frustoconical layout of the abutment head and a complementary frustoconical layout of the cavity laid-out inside the cap.
It is understood that the retaining means are both means of retention by close contact between the abutment head and the cavity provided in the cap which are laid out in respective frustoconical shapes complementary to each other and by means of screwing the cap onto the abutment head. In other words, the cap is held removably on the abutment head both by means of screwing of the cap onto the abutment head and by the Morse taper layout of the abutment head and the cavity of the cap. It is further understood that the cap is both force-fit and screwed onto the abutment based on the retention means by nesting and by screwing which engages both of them.
The abutment head is laid out in a first frustoconical portion a transverse section of which tends to get smaller between a flange delimiting the abutment head and the abutment body, and an upper abutment end which gives the abutment head a frustoconical layout.
The abutment comprises the abutment head and the abutment body which together form the single piece assembly in the meaning where the abutment head and the abutment body are inseparable from each other except because of deterioration of one and/or the other. It is understood that the abutment, and therefore the abutment head and the abutment body, results for example from a single machining, molding, foundry or similar operation. In that way, the abutment is one continuous material from the abutment head to the abutment body.
The abutment is intended to be built up on the dental implant, in particular by screwing or the like.
The screwing means include a cap-attachment screw at least partially housed inside an axial abutment channel which the abutment comprises.
The cap-attachment screw comprises a lower cap screw and which is provided with a cap screw threading engaging with an abutment threading which is complementary to the cap screw threading and which is arranged on an inner abutment surface delimiting the abutment axial channel.
The cap-attachment screw comprises an upper cap screw comprising a cap screw head which is in contact against a cap shoulder provided on an inner cap surface, where the inner cap surface at least partially delimits the cavity, and where the inner cap surface is laid out at least partially in a second conic portion with a shape complementary to the first conic portion according to which the abutment head is laid out.
The cap-attachment screw extends at least partially inside an axial cap channel comprising an upper zone which houses the cap screw head in which it is delimited at least partially by the cap shoulder, with axial cap channel comprises an intermediate zone which houses an axial crown and at least one radial finger which the abutment head comprises, and where the intermediate zone is interposed between the upper zone and the cavity.
The inner cap surface is provided with a tab which is intended to come into contact against an outer abutment surface and which extends from a lower cap end to a contact point, where the contact point is arranged at a first distance from the lower cap end which is below a second distance taken between the lower cap end and a cone lip which the inner cap surface comprises.
A spacing is provided between the contact point and the cone lip between the outer abutment surface and the inner cap surface.
This spacing reduces contact between the abutment head and the cap.
The combination of screwing means and nesting means is advantageous in the sense that a reduction of the nesting means based on the presence of the spacing is compensated by the presence of the screwing means. Finally, an ease of placement and optimization of attachment of the cap on the abutment head follows from this, while guaranteeing an easy withdrawal of the cap.
The cap is provided with a prosthesis.

Other characteristics, details and advantages of the invention will appear more clearly upon reading the description given below for illustration in connection with the drawings.

### BRIEF DESCRIPTION OF THE DRAWINGS

FIG. 1 is a schematic section view of the dental prosthetic device from the present invention.

FIG. 2 is a detailed view of the dental prosthetic device shown in FIG. 1.

FIG. 3 is also a detailed view of the dental prosthetic device shown in FIG. 1.

FIG. 4 is an exploded perspective view of a first variant of a cap and a cap-attachment screw constituting the dental prosthetic device shown in FIGS. 1 to 3.

FIG. 5 is a bottom perspective view of the cap shown in FIG. 4.

FIG. 6 is a perspective view of an implant provided with an abutment which constitutes the dental prosthetic device shown in FIGS. 1 to 3 and a range of a second cap variant.

FIG. 7 is a perspective view of a variant of the abutment shown in FIGS. 1 to 3 and 6.

In the figures, a dental prosthetic device and/or constituent elements of the prosthetic dental device are shown such that an element qualified as “upper” is oriented upward and a “lower” element is oriented downward. It is thus understood that such an element is more specifically shown as if it were assigned to a lower jaw of a patient in position of use. It is also understood that an element could be assigned to an upper jaw of the patient by reversing the direction of orientation. It follows from this that the qualifications “upper” and “lower” are in particular to be understood in light of the relative position thereof on the figures, where the qualification “upper” is assigned to an element oriented towards the top of the figure and the qualifier “lower” is assigned to an element oriented towards the bottom of the figure.

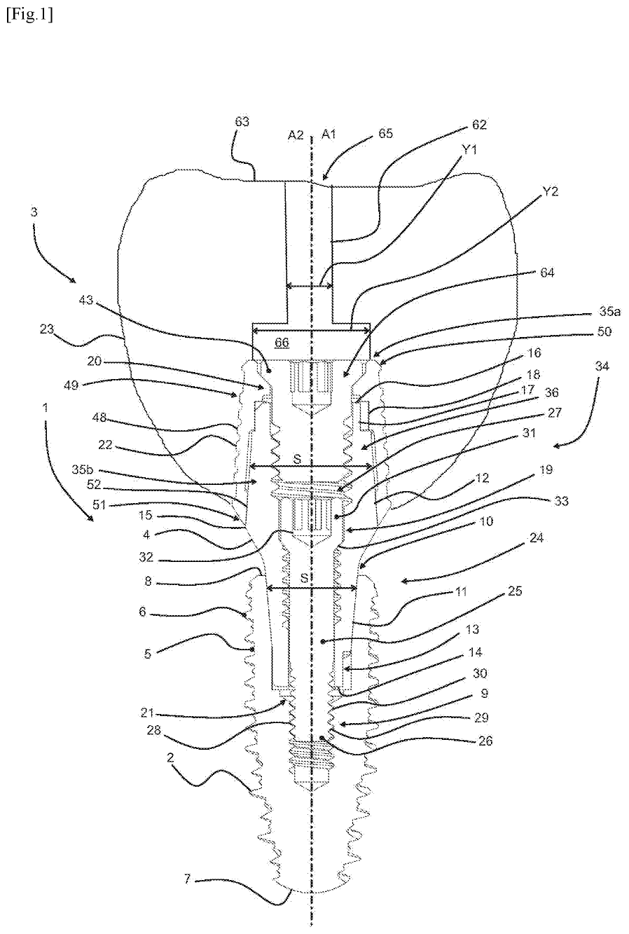

In FIG. 1, a dental prosthetic device 1 from the present invention is shown assembled in a position for use for replacement of a tooth of the patient. The dental prosthetic device 1 comprises at least one implant 2, a cap 22 and an abutment 4 which is interposed between the implant 2 and the cap 22. The dental prosthetic device 1 extends mainly along an axis of extension A1, which for example forms an axis of revolution of the dental prosthetic device 1.

According to the variant shown in FIGS. 1 to 5, the cap 22 is combined or else intended to be combined with a prosthesis 23 which can be seen in FIG. 1 in order to together constitute a capsule 3 intended to permanently replace a tooth from a patient. More specifically, the prosthesis 23 is sealed on the cap 22.

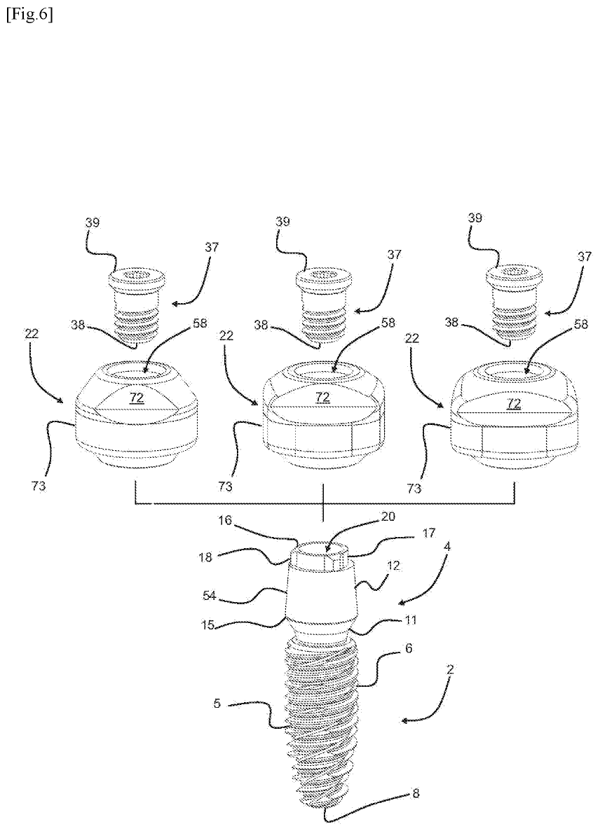

According to a variant shown in FIG. 6, the cap 22 is a healing cap intended for being temporarily implanted in a patient.

At this stage of the description note that the present invention which covers in particular the way in which the cap 22 is held on the abutment 4 applies without distinction to a cap 22 provided with a prosthesis 23 or a healing cap without any such prosthesis.

The implant 2 is intended to be attached, in particular by screwing or the like, to the inside of the bone of a patient. For this purpose, the implant 2 comprises an outer implant surface 5 which is provided with one, or even several, screwing ramp(s) 6 in particular laid out in a helix, whose axis of revolution A2 is coincident with the axis of extension A1. Along the axis of extension A1, the implant 2 extends from a lower implant surface 7 to an upper implant surface 8 which are substantially orthogonal to the axis of extension A1. The lower implant surface 7 is the one which is intended to be placed the deepest inside the bone of the patient.

The implant 2 comprises an axial implant channel 9 which opens out through the upper implant surface 8 and which does not open out through the lower implant surface 7. In that way, the axial implant channel 9 comprises an axial implant opening 10 through which the abutment 4 is inserted inside the axial implant channel 9. The axial implant channel 9 extends parallel to the axis of extension A1.

The abutment 4 comprises an abutment body 11 which is intended to be housed inside the axial implant channel 9 and an abutment head 12 which is intended to emerge above the axial implant opening 10. In other words, the abutment 4 is formed of a single unit assembly made up of the abutment head 12 and the abutment body 11. According to the variant shown, the abutment 4 is a straight abutment in the sense where the abutment body 11 and the abutment head 12 both extend along a respective axis which is coincident with the axis of extension A1. According to the variant shown again, the abutment body 11 comprises a material clearance 13 which allows an indexing of the abutment 4 inside the axial implant opening 10, so as to avoid a rotation of the abutment 4 around itself inside the axial implant opening 10 around the axis of extension A1. Preferably, the material clearance 13 is laid out at a lower abutment end 14 which is the one arranged at the bottom of the axial implant opening 10. The material clearance 13 is for example complementary to a material excess of the implant 2 which comes to be encased inside the material clearance 13. According to an implementation variant, the abutment body 11 does not have any such material clearance.

The abutment body 11 is overall arranged in a cone flared towards the abutment head 12. In other words, a transverse section S of the abutment 4 taken orthogonally to the axis of extension A1 tends to increase from the lower abutment end 14 to a flange 15 which delimits the abutment body 11 and the abutment head 12. The abutment head 12 is laid out in a cone whose transverse section S decreases between the flange 15 and an upper abutment end 16. More specifically, the abutment head 12 is laid out in a first frustoconical portion 91 which gives the abutment head 12 a frustoconical arrangement. The upper abutment end 16 is laid out in an axial crown 17 provided with at least one radial finger 18 intended for indexing a positioning of the capsule 3 on the abutment 4. The upper abutment end 16 is axially opposite the lower abutment end 14.

The abutment 4 comprises an axial abutment channel 19 which opens out through the upper abutment end 16 and the lower abutment end 14. In that way, the axial abutment channel 19 extends between an upper abutment opening 20 and a lower abutment opening 21. The axial abutment channel 19 extends parallel to the axis of extension A1, according to the variant shown.

The abutment body 11, and subsequently the abutment 4 is built up on the implant 2 via the attachment means 24 of the abutment body 11 at least partially inside the axial implant channel 9.

The attachment means 24 comprise an abutment attachment screw 25 which comprises a lower abutment-screw end 26 and an upper abutment-screw end 27, where the abutment attachment screw 25 extends along the axis of extension A1 between the lower abutment-screw end 26 and the upper abutment-screw end 27. The lower abutment-screw end 26 is equipped with an abutment-screw thread 28 engaging with an implant thread 29 which is complementarily to the abutment screw thread 28 and which is laid out in the implant 2, more specifically on an inner implant surface 30 delimiting the axial implant channel 9. The upper implant screw end 27 comprises an abutment screw head 31 provided for example with an abutment six-pans bore 32 which allows the abutment 4 to be screwed onto the implant 2 with an appropriate tool. The abutment screw head 31 comes into tight contact against an abutment shoulder 33 laid out on the inner abutment surface 42 so as to reliably and removably attach the abutment 4 onto the implant 2, such that the abutment 4 and in particular the abutment head 12 remain immobile.

The abutment head 12 receives the cap 22 via retaining means 34 which provide a reliable and removable hold of the cap 22 on the abutment head 12.

The retaining means 34 advantageously comprise means of screwing 35a the cap 22 onto the abutment head 12 and means of nesting 35b the abutment head 12 inside a cavity 36 arranged inside the cap 22. In other words, the retaining means 34 combine together means of screwing 35a the cap 22 onto the abutment head 12 and means of nesting 35b inside the cavity 36 in close contact with the abutment head 12. In other words, the cap 22 is held removably on the abutment head 12 both by means of screwing 35a of the cap 22 onto the abutment head 12 and by the Morse taper layout of the abutment head 12 and the cavity 36 of the cap 22. It is further understood that the cap 22 is both force-fit and screwed onto the abutment head 12 based on the retention means 34 by nesting and by screwing which engages both of them.

Advantageously, these arrangements are such that the retention means 34 are reliable and robust, while providing some flexibility of use, whether the screwing means 35a are used or not by a practitioner for building up the cap 22 on the abutment 4.

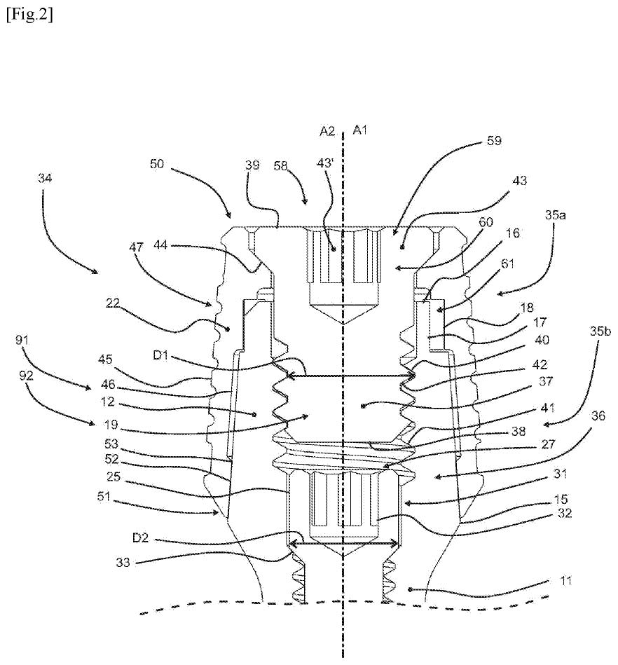

Also referring to FIG. 2, the cap 22 is built upon the abutment head 12 via screwing means 35a of the cap 22 on the abutment head 12. The screwing means 35a comprise a cap attachment screw 37 which comprises a lower cap-screw end 38 and an upper abutment-screw end 39, where the cap attachment screw 37 extends along the axis of extension A1 between the lower abutment-screw end 38 and the upper abutment-screw end 39. The lower cap-screw end 37 is equipped with a cap screw thread 40 engaging with an implant thread 41 which is complementarily to the cap screw thread 40 and which is laid out in the abutment 4, more specifically on the abutment head 12, and more specifically on an inner abutment surface 42 delimiting the axial abutment channel 19. The upper cap-screw end 39 comprises a cap screw head 43 provided for example a cap six-pans bore 43′ which allows the cap 22 to be screwed onto the abutment head 12 with an appropriate tool. The cap screw head 43 comes into close contact against the cap shoulder 44 laid out on an inner cap surface 46 so as to reliably attach the cap 22 onto the abutment 4.

It should be noted at this stage of this description that a first minimum diameter D1 of the axial abutment channel 19 is greater than a second maximum diameter D2 of the abutment attachment screw 25 in order to allow the abutment attachment screw 25 to pass inside the axial abutment channel 19. The first minimum diameter D1 of the axial abutment channel 19 is measured orthogonally to the axis of extension A1 between two diametrically opposite elements closest to the inner abutment surface 42, such as points of the abutment threading 41. The second maximum diameter D2 of the abutment attachment screw 25 is measured orthogonally to the axis of extension A1 between two diametrically opposite elements closest to the abutment attachment screw 25, such as points of the abutment screw head 31.

The cap 22 is also built up on the abutment head 12 via nesting means 35b of the cap 22 on the abutment head 12. The frustoconical layout of the abutment head 12 previously described is complementary to a frustoconical layout of the cavity 36 arranged inside the cap 22.

For this purpose, and according to the variant shown in FIGS. 1 to 5, the cap 22 is arranged overall in a sleeve delimited by an outer cap surface 45 and an inner cap surface 46. The outer cap surface 45 is provided with cap grooves 47 which are shaped complementarily to prosthesis grooves 48 laid out on an inner prosthetic surface 49, such as more specifically shown in FIG. 1. The inner cap surface 46 is the surface which at least partially delimits the cavity 36 and which is laid out at least partially in a second conical portion 92 with complementary shape to the first conical portion 91 according to which the abutment head 12 is laid out.

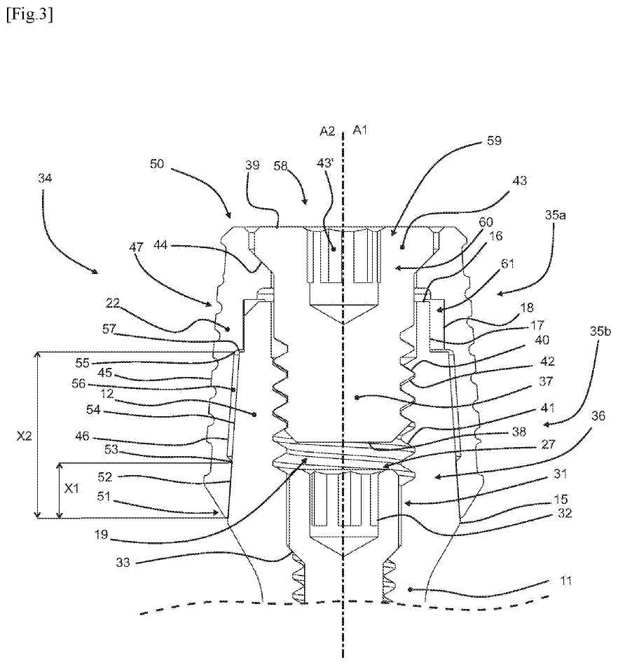

Also referring to FIG. 3, the cap 22 extends axially along the axis of extension A1 between an upper cap end 50 and a lower cap end 51. The lower cap end 51 is preferably arranged near the flange 15 which delimits the abutment body 11 and the abutment head 12. The inner cap surface 46 is provided with a tab 52 which extends radially around the axis of extension A1 and which extends axially from the lower cap end 51 to a contact point 53. The tab 52 forms a contact surface intended to come into contact against an outer abutment surface 54 which delimits the abutment head 12 on the outside and which is laid out frustoconically. The contact point 53 is laid out at a first distance X1, taken between the lower cap end 51 and the contact point 53 parallel to the axis of extension A1, which is less than the second distance X2, taken parallel to the axis of extension A1 between the lower cap end 51 and the cone lip 55 which the inner cap surface 46 comprises. The first distance X1 is preferably less than half of the second distance X2, more preferably less than a quarter of the second distance X2. The function of the tab 52 is to provide a seal between the cap 22 and the abutment head 12 in order to avoid the entry of dirt between the cap 22 and the abutment head 12. It is understood that a spacing 56 is provided between the contact point 53 and the cone lip 55 between the outer abutment surface 54 and the inner cap surface 46. This spacing 56 reduces contact between the abutment head 12 and the cap 22, which reduces a hold by nesting of the capsule 3 on the abutment head 12, where the means of screwing 35a of the capsule 3 on to the abutment head 12 compensates for this reduction. Note here the advantageous combination of screwing means 35a and nesting means 35b, since the reduction of one is compensated by the presence of the other. Finally, because of this, an ease of placement and an optimization of attachment of the cap 22 onto the abutment head 12 emerges while also guaranteeing an ease of withdrawal of cap 22 by via use of screwing means 35a in the first place and then nesting means 35b.

Note therefore that the conical arrangement of the inner cap surface 46 extends axially at least between the lower cap end 51 and the contact point 53 and more generally between the lower cap end 51 and the cone lip 55.

Also note that the conical arrangement of the outer abutment surface 54 extends axially between the flange 15 and the contact point 53, and more generally between the flange 15 and a cone edge 57 which the outer abutment surface 54 comprises. The cone edge 57 is arranged facing, and preferably in contact with, the cone lip 55. Note also that the axial crown 17 of the abutment head 12 extends axially between the cone edge 57 and the upper abutment end 16.

The upper cap end 50 is provided with an upper cap opening 58 which allows insertion of the cap-attachment screw 37 inside an axial cap channel 59 which extends axially between the cap upper end 50 and the cap lower end 51 and which comprises the cavity 36. More specifically, the axial cap channel 59 comprises an upper zone 60 which is intended to house the cap screw head 43 and which is delimited at least partially by the cap shoulder 44. The upper zone 60 extends above an intermediate zone 61 that also comprises the axial cap channel 59 and which is intended to house the axial crown 17 of the abutment head 12 and the radial fingers 18. The intermediate zone 61 is interposed between the upper zone 60 and the cavity 36.

Referring again to FIG. 1, the prosthesis 23 is equipped with an axial prosthetic channel 62 which extends axially between an upper prosthetic surface 63 and an orifice 64 which is shaped for receiving the cap 22. The axial prosthetic channel 62 extends mainly along the axis of extension A1. The orifice 64 is in particular delimited by the inner prosthetic surface 49. More specifically, the axial prosthetic channel 62 extends between an upper prosthetic opening 65 and the orifice 64. The axial prosthetic channel 62 comprises a chamber 66 which extends radially above the cap 22. In other words, the chamber 66 extends above the cap 22 such that the cap screw head 43 is housed inside the chamber 66 during an operation of unscrewing the cap-attachment screw 37 by means of an appropriate tool housed inside the axial prosthetic channel 62 which is used for unscrewing the cap-attachment screw 37. Note that a channel diameter Y1 taken orthogonally to the axis of extension A1 between two diagonally opposite points of the axial prosthetic channel 62 is distinctly less than a chamber diameter Y2 taken orthogonally to the axis of extension A1 between two diametrically opposite points of the chamber 66. In fact, the axial prosthetic channel 62 is shaped in order to allow the aforementioned tool to pass whereas the chamber 66 is shaped in order to house the cap screw head 43.

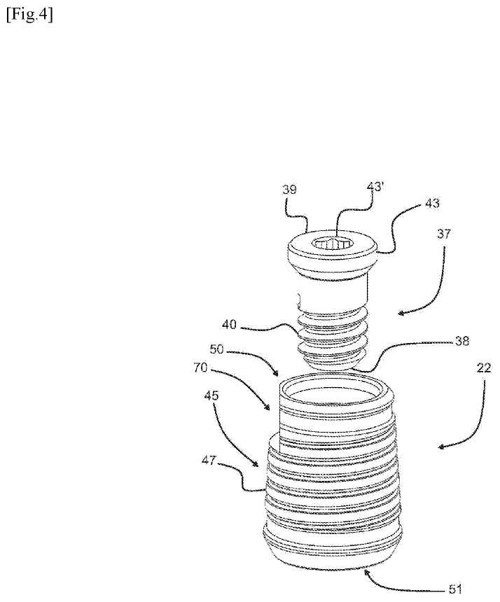

In FIG. 4, the cap 22, and more specifically the outer cap surface 45 is provided with an indexing flat 70 which is intended to orient the prosthetic 23 when sealing the prosthesis 23 and the cap 22 together.

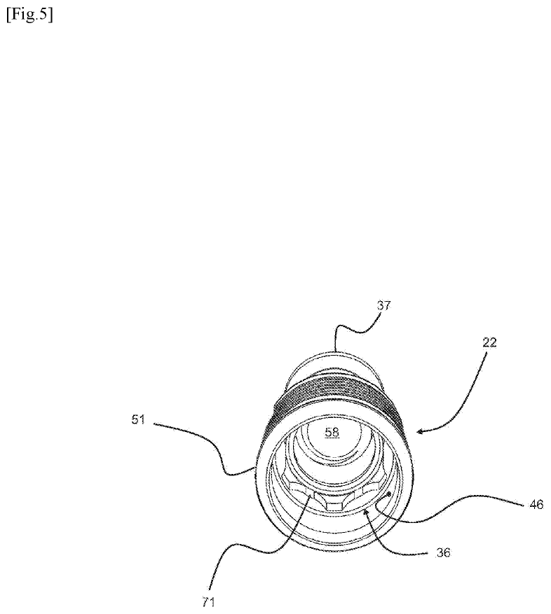

In FIG. 5, inner cap surface 46 which at least partially delimits the cavity 36 is provided with at least one member 71 suited for engaging with the radial finger 18 of the abutment head 12 so as to index the cap 22 on the abutment 4.

In FIG. 6, the abutment 4 through screwed to the inside of the implant 2 is suited for receiving three distinct caps 22, caps for healing in the case shown, which are each provided with an imprint flat 72 forming a reference zone for the cap 22 to which the imprint flat 72 is assigned. It is understood that the abutment 4 is suited for receiving various shape caps comprising in particular a peripheral surface 73 of overall circular, triangular or square section, as shown from left to right for the caps 22.

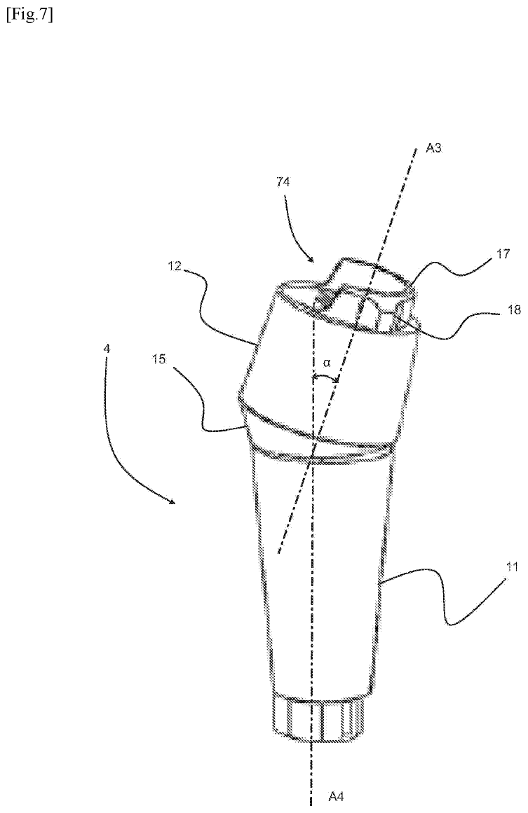

In FIG. 7, the abutment 4 is an angular abutment for which the abutment head 12 and the abutment body 11 extend along respective axes of extension A3, A4 forming between them an acute angle a which is nonzero and is preferably included between 5° and 25°.

1. A dental prosthetic device (1) extending principally along an axis of extension (A1) and comprising at least one implant (2), one cap (22) and an abutment (4) which is interposed between the implant (2) and the cap (22), where the abutment (4) comprises an abutment body (11) provided with means of attachment (24) to the implant (2), where the abutment (4) comprises an abutment head (12) which is at least partially delimited by an outer abutment surface (54) and which is equipped with means (34) for retaining the cap (22), the retaining means (34) comprise means (35b) of nesting the abutment head (12) inside a cavity (36) which is formed inside the cap (22) and which is at least partially delimited by an inner cap surface (46), and the retaining means (34) comprise means (35a) for screwing the cap (22) onto the abutment head (12), characterized in that the inner cap surface (46) is provided with a tab (52) which is in contact against the outer abutment surface (54), where a spacing (56) is arranged axially between a contact point (53) of the inner cap surface (46) and a cone lip (55) of the inner cap surface (46) and radially between the outer abutment surface (54) and the inner cap surface (46).

2. The dental prosthetic device (1) according to claim 1, characterized in that the tab (52) extends radially around the axis of extension (A1) of the dental prosthetic device (1) and extends axially from a lower cap end (51) to the contact point (53).

3. The dental prosthetic device (1) according to any one of the preceding claims, characterized in that the tab (52) forms a sealing member between the cap (22) and the abutment head (12), where the sealing member is laid out for avoiding the entry of dirt between the cap (22) and the abutment head (12).

4. The dental prosthetic device (1) according to any one of claims 2 and 3, characterized in that the contact point (53) is arranged at a first distance (X1) from the lower cap end (51) which is less than a second distance (X2) taken between the lower cap end (51) and the cone lip (55).

5. The dental prosthetic device (1) according to claim 4, characterized in that the first distance (X1) is preferably less than half of the second distance (X2).

6. The dental prosthetic device (1) according to any one of claims 4 and 5, characterized in that the first distance (X1) is less than one quarter of the second distance (X2).

7. The dental prosthetic device (1) according to any one of claims 2 to 6, characterized in that the lower cap end (51) adjoins a flange (15) which delimits the abutment body (11) and the abutment head (12).

8. The dental prosthetic device (1) according to any one of the preceding claims, characterized in that the nesting means (35b) comprise a frustoconical layout of the abutment head (12) and a complementary frustoconical layout of the cavity (36) laid-out inside the cap (22).

9. The dental prosthetic device (1) according to any one of the preceding claims, characterized in that the abutment head (12) is laid out at least partially in a first conical portion (91) with a shape complementary to a second conical portion (92) according to which the inner cap surface (46) is at least partially laid out.

10. The dental prosthetic device (1) according to claim 9, characterized in that the second conical portion (92) extends axially at least between the lower cap end (51) and the cone lip (55).

11. The dental prosthetic device (1) according to claim 10, characterized in that the second conical portion (92) extends axially between the lower cap end (51) and the contact point (53).

12. The dental prosthetic device (1) according to any one of claims 9 to 11, characterized in that the first conical portion (91) extends axially at least between the flange (15) and a cone edge (57) which the outer abutment surface (54) comprises.

13. The dental prosthetic device (1) according to claim 12, characterized in that the first conical portion (91) extends axially between the flange (15) and the contact point (53).

14. The dental prosthetic device (1) according to any one of claims 12 and 13, characterized in that the cone edge (57) is arranged facing the cone lip (55).

15. The dental prosthetic device (1) according to any one of claims 12 to 14, characterized in that the cone edge (57) is in contact with the cone lip (55).

16. The dental prosthetic device (1) according to any one of claims 12 to 15, characterized in that the abutment head (12) comprises an axial crown (17) which extends axially between the cone edge (57) and an upper abutment end (16).

17. The dental prosthetic device (1) according to any one of the preceding claims, characterized in that the abutment (4) is formed of a single unit assembly comprising the abutment head (12) and the abutment body (11).

18. The dental prosthetic device (1) according to any one of the preceding claims, characterized in that the screwing means (35a) include a cap-attachment screw (37) at least partially housed inside an axial abutment channel (19) which the abutment (4) comprises.

19. The dental prosthetic device (1) according to claim 18, characterized in that a first minimum diameter (D1) of the axial abutment channel (19) is greater than a second maximum diameter (D2) of the abutment attachment screw (25).

20. The dental prosthetic device (1) according to any one of claims 18 and 19, characterized in that the cap-attachment screw (37) comprises a lower cap screw end (38) which is provided with a cap screw threading (40) engaging with an abutment threading (41) which is complementary to the cap screw threading (40) and which is arranged on an inner abutment surface (42) delimiting the axial abutment channel (19).

21. The dental prosthetic device (1) according to any one of claims 18 to 20, characterized in that the cap-attachment screw (37) comprises an upper cap screw end (39) comprising a cap screw head (43) which is in contact against a cap shoulder (44) arranged on the inner cap surface (46).

22. The dental prosthetic device (1) according to claim 21, characterized in that the cap-attachment screw (37) extends at least partially inside an axial cap channel (59) comprising an upper zone (60) which houses the cap screw head (43) and which is delimited at least partially by the cap shoulder (44).

23. The dental prosthetic device (1) according to claims 16 and 22, characterized in that the axial cap channel (59) comprises an intermediate zone (61) which houses the axial crown (17) and at least one radial finger (18) which the abutment head (12) comprises.

24. The dental prosthetic device (1) according to claim 23, characterized in that the intermediate zone (61) is interposed between the upper zone (60) and the cavity (36).

25. The dental prosthetic device (1) according to claims 2, 16 and 18, characterized in that the cap (22) extends axially between an upper cap end (50) and the lower cap end (51), where the upper cap end (50) is provided with an upper cap opening (58) which is shaped to allow insertion of the cap-attachment screw (37) inside the axial cap channel (59) which extends axially between the cap upper end (50) and the cap lower end (51) and which comprises the cavity (36).

26. The dental prosthetic device (1) according to claims 21 and 25, characterized in that the axial cap channel (59) comprises an upper zone (60) which is intended to house the cap screw head (43) and which is delimited at least partially by the cap shoulder (44).

27. The dental prosthetic device (1) according to claims 23 and 26, characterized in that the upper zone (60) extends above an intermediate zone (61) of the axial cap channel (59), where the intermediate zone (61) houses the axial crown (17) of the abutment head (12) and the radial finger (18).

28. The dental prosthetic device (1) according to claim 27, characterized in that the intermediate zone (61) is interposed between the upper zone (60) and the cavity (36).

29. The dental prosthetic device (1) according to any one of the preceding claims, characterized in that the cap (22) is provided with a prosthesis (23).

30. The dental prosthetic device (1) according to claim 27, characterized in that the prosthesis (23) is equipped with an axial prosthetic channel (62) which extends axially between an upper prosthetic surface (63) and an orifice (64) which is shaped for receiving the cap (22).

31. The dental prosthetic device (1) according to claim 30, characterized in that the axial prosthetic channel (62) extends between an upper prosthetic opening (65) and the orifice (64), where the axial prosthetic channel (62) comprises a chamber (66) extending above the cap (22), and where the chamber (66) is laid out for housing the cap screw head (43) during an operation of unscrewing the cap-attachment screw (37).

32. The dental prosthetic device (1) according to claims 2 and 31, characterized in that a channel diameter (Y1) taken orthogonally to the axis of extension (A1) between two diagonally opposite points of the axial prosthetic channel (62) is less than a chamber diameter (Y2) taken orthogonally to the axis of extension (A1) between two diametrically opposite points of the chamber (66).

33. The dental prosthetic device (1) according to claims 2 and 29, characterized in that the cap (22) comprises an outer cap surface (45) which is provided with an indexing flat (70) intended to index the prosthesis (23) on the cap (22).

34. The dental prosthetic device (1) according to any one of claims 23 to 33, characterized in that inner cap surface (46) is provided with at least one member (71) suited for engaging with the radial finger (18) of the abutment head (12) so as to index the cap (22) on the abutment (4).
